(19) United States
(12) Patent Application Publication
(10) Pub. No.: US 2023/0068550 A1
(43) Pub. Date: Mar. 2, 2023

(54) System for Near-Term Mitigation of Space Debris

(71) Applicant: Stephen Paul Rojas, Washington, DC (US)

(72) Inventor: Stephen Paul Rojas, Washington, DC (US)

(73) Assignee: Redtower Enterprises, LLC (DBA Redtower Labs), Washington, DC (US)

(21) Appl. No.: 17/863,090

(22) Filed: Jul. 12, 2022

Related U.S. Application Data
(60) Provisional application No. 63/237,553, filed on Aug. 27, 2021.

(51) Int. Cl. B64G 3/00; B64G 7/00

(52) U.S. Cl. CPC B64G 3/00; B64G 7/00

(57) ABSTRACT

An improved debris generator that can be used as part of a space object modeling (SOM) system to turn any active spacecraft into a debris sensor for characterizing and cataloging space debris. The space debris generator includes an extractor which extracts satellite sensor data into a sensor store, an impact agent which estimates “on the fly” new debris field objects generated by the collision, and an injector which stores the enhanced object data on a central server for near-term mitigation of impact driven breakup events. The impact agent is an artificial neural network trained using a large number of simulations of impact events.

### FIELD OF THE INVENTION

The present invention relates to space debris, and more specifically, to a system for quickly characterizing the current debris environment and assessing the future debris population using sensor data, mathematical algorithms, and data-driven techniques, commonly referred to as machine learning.

### BACKGROUND OF THE INVENTION

Critical satellite assets in earth orbit are increasingly threatened by space debris. A piece of debris as small as 1 cm can catastrophically damage an operational satellite if a sensitive component is hit. One way to address this threat is to track orbital debris with radar or telescopes and use that information to maneuver an at risk satellite out of harm's way. However, this approach is problematic because less than 3% of potentially hazardous debris objects (or “particles”) are regularly tracked by space surveillance networks and maintained in their catalogs. Orbital debris in the range of 1-10 cm is effectively outside the range of current tracking capabilities, posing an unaddressed risk to a growing population of expensive space assets that our society is increasingly reliant upon. Complicating matters is the fact that if an untracked piece of orbital debris impacts an operational satellite, the event can generate new fragments which could then threaten another satellite causing a chain reaction of destructive impacts (see non-patent literature, The Kessler Syndrome: Implications to Future Space Operations, D. J. Kessler et al, 2010). Operational satellite breakup events can result in tens or possibly hundreds of thousands of debris fragments which pose an immediate risk to other satellites. Historically, satellite breakups average 4-5 events per year and this is likely to increase as orbital traffic grows. Therefore, short term risk mitigation after an impact driven breakup event is of paramount importance.

Currently, detecting an operational satellite breakup event and determining the short-term hazard can be a laborious, time consuming process fraught with uncertainty. The debris fragments generated by a high-energy impact driven satellite breakup are generally too small for current ground-based tracking capabilities to accurately catalog the shed fragments or provide actionable information. If no trackable debris is generated, then the breakup event could go unnoticed until long after the event when resources can be committed to gathering data and performing a detailed analysis. In some cases, the impact driven breakup event itself may never be detected leaving an unknown number of un-catalogued fragments hidden until they manifest themselves in another damaging collision.

If larger trackable objects are involved, then, a breakup is historically identified when a ground based orbital analyst tasked with monitoring Space Surveillance Network (SSN) RADAR observes a single cataloged space object as having multiple pieces where one piece was expected (see non-patent literature, Satellite Breakup Risk Mitigation, Darrin P. Leleux et al, 2006). If a breakup event is identified this way, USSTRATCOM notifies the community and, if manpower is available, a Monte Carlo simulation is performed to characterize the satellite breakup and develop a probability of catastrophic collision between the debris cloud and the vehicle of interest at each possible orbital intersection. If RADAR or SSN data is not available or timely, then the resulting hazard prediction, if one is done at all, will likely be inaccurate and too late. Satellite operators are generally not willing to execute a potentially costly debris avoidance maneuver if risk estimates are highly inaccurate or not timely. This can present a large amount of uncertainty to decision makers eager protect expensive satellites from damage. A new method for quickly cataloging shed fragments from an event and mitigating the near-term hazard is needed.

When a piece of debris impacts a spacecraft, it can generate shock waves, plastic deformation, and fragmentation of the spacecraft, often referred to as a debris cloud or ejecta. This process depends on a number of factors including the impacting object's mass, density, velocity, shape, impact location, and impact angle. If sufficient data is available, simulations of collision debris that match experiment can be made using computer codes that capture shock waves and model the dynamic material response, often referred to as hydrocodes or hydrodynamic simulation. Highly detailed predictions can be made with this method, but their use for the orbital debris problem has been limited by the time required to construct and run the models. In addition, without knowledge of data that describes the object that impacted the spacecraft, the utility of stand-alone hydrocode analysis for near-term risk mitigation is further constrained (see non-patent literature: Satellite Collision Modeling with Physics-Based Hydrocodes: Debris Generation Predictions of the Iridium-Cosmos Collision Event and Other Impact Events, Springer, H. K. et al, 2010). In analogous circumstances to the orbital debris problem, data driven methods have been used in conjunction with the power of hydrocodes (see non-patent literature: Machine Learning Applied to Simulations of Collisions Between Rotating, Differentiated Planets, M. Timpe et al, 2020), however, not in combination with spacecraft sensor data for near-term debris risk mitigation. Similarly, other analyses have investigated orbital debris impact dynamics using hydrocodes (see for example, non-patent literature: Orbital Debris Momentum Transfer in Satellite Shields Following Hypervelocity Impact, and Its Application to Environment Validation, J. Williamsen et al, 2017), but not within a sensor integrated, data driven framework for near-term orbital debris risk mitigation.

Current methods to address the lack of accurate object data include passive and active impact sampling and remote sampling from either orbit or earth (see non-patent literature, Orbital Debris, A Technical Assessment, Committee on Space Debris, Aeronautics and Space Engineering Board, 2004). Passive impact sampling involves exposing surfaces in orbit and then returning them to Earth for examination. While this method can provide useful information on the ground about the damage a satellite incurred from orbital debris, it is not practical, both economically and technically, to return a large number of samples back to earth after time in orbit. Active impact sampling involves deploying spacecraft and sensors specially designed to sample and characterize the debris population. Active methods, such as capacitive discharge impact detectors or optical photometers, can provide useful information about the strike, however, the cost/benefit ratio of deploying and operating them with existing methods makes them impractical as a means to quickly and inexpensively characterize and catalog the current debris population.

The availability of accurate object data severely limits existing methods because the collision of an object with a spacecraft, and subsequent generation of hazardous debris, is a complex physical process that is highly sensitive to the impacting object's characteristics (see non-patent literature: NASA's Efforts to Mitigate the Risks Posed by Orbital Debris, NASA Office of Inspector General, 2021). This limitation is currently addressed within SOM system debris generators by making statistical assumptions or limiting simplifications (eg: empirical or analytic) about the end-to-end physical process and associated parameters (see, for example, non-patent literature: Analytical Model for the Propagation of Small Debris Object Clouds After Fragmentations, F. Letizia et al, 2014; Key Aspects of Satellite Breakup Modeling, Darren McKnight et al, 1993; Space Debris Modeling at NASA, Nicholas L. Johnson, 2001). This approach is not practical because it results in inaccurate estimates of future debris characteristics and hence poor estimates of future risk to the spacecraft population in orbit. For example, some methods may assume that an impacting object is composed of aluminum or aluminum oxide, when in reality it may be composed of higher density materials such as stainless steel, copper, or silver. The impracticality of using poor object data in a SOM debris generator is especially evident when considering the fact that objects from a given collision are often iteratively fed into follow on collisions such that the inaccurate results of the first debris generation are amplified with each successive collision in the simulation (see U.S. Pat. No. 9,586,704 B2 Modeling the Long Term Evolution of Space Debris). Without an on-the-fly physics based method to better characterize an impact, this amplification effect can result in very large errors in assessed risk in both the near and long term.

In addition to the local effects stemming from the high velocity impact, the satellite's motion in orbit is changed such that it's altitude, velocity, rotation rates, and spin axes are perturbed (see, for example, non-patent literature: Improving Orbital Debris Environment Predictions Through Examining Satellite Movement Data, J. Williamsen et al, 2020); Assessing Debris Strikes in Spacecraft Telemetry: Development and Comparison of Various Techniques, A. Bennett et al, 2021). Specifically, the debris cloud generated by the impact causes a net transfer of momentum to the satellite, often referred to as a “momentum enhancement factor”, β, defined as:

$$\begin{matrix}β = \frac{{p}_{p o s t}}{{p}_{p a r t i c l e}} \\ = \frac{M d V}{{m}_{0} {v}_{0}}\end{matrix} \qquad ( 1 )$$

where:
pₚₒₛₜ=post impact momentum of the spacecraft
p_{particle}=pre-impact momentum of the impacting particle
M=mass of the satellite
dV=change in velocity of the satellite
m₀=impacting particle mass
v₀=impacting particle velocity

Current methods treat the processes described by Equation 1—from pre-impact problem characterization to post impact fragment generation—as decoupled analyses that cannot be conducted “on-the-fly” and do not capitalize on existing satellite sensor information. As a result, these methods are too slow and inaccurate to be of use to satellite operators for near-term risk mitigation. There exists a need therefore for an integrated system that can characterize the pre-impact conditions and quickly tell satellite operators with high accuracy if their spacecraft is on a collision course with fragment debris.

### DESCRIPTION OF RELATED ART

Of particular relevance to the current invention,

Provisional application No. 63/237,553, System for Near Term Mitigation of Space Debris, filed on Aug. 27, 2021

discloses a debris generator that can be used as part of a SOM system to turn any active spacecraft into a debris sensor for characterizing and cataloging space debris.

US 2014/0330544 A1 Modeling the Long-Term Evolution of Space Debris, Filed on Nov. 6, 2014

U.S. Pat. No. 9,586,704 B2 Modeling the Long-Term Evolution of Space Debris, Filed on Mar. 7, 2017

disclose a SOM system for modeling the long term evolution of space debris.

### SUMMARY OF THE INVENTION

The present invention relates to a coherent methodology for collecting available spacecraft sensor data and quickly converting it into information that can be used by the spacecraft design and operation community to mitigate future risks. The invention is a SOM debris generator which turns any active spacecraft into an in-situ node in a network for characterizing and cataloging the debris field. The debris generator operates by passing satellite sensor data through a series of components—the extractor, impact agent, and injector—producing a predicted debris cloud that is automatically calibrated to observed in-situ impacts.

The extractor ingests sensor data from a satellite impact event by comparing the expected orbital parameters to the actual orbital parameters and flagging a mismatch as a perturbation event. When a satellite collides with a space object, it's motion is perturbed. The extractor tests for this perturbation and stores sensor data about the satellite's resulting dynamic movement if one is detected. An example of a perturbation event would be an un-commanded change in spacecraft velocity, resulting in changes to the vehicle's altitude; this information is extracted and used by the impact agent to generate a target, pₚₒₛₜ. Extractor data may be transmitted to the sensor store via spacecraft telemetry or transmitted via wired connections when ground based sensor platforms are used in an embodiment.

The impact agent uses data about the satellite's perturbation induced motion to estimate post-impact parameters, namely the debris velocity vectors, \vec{n}_{deb,i}. Sensor derived data, such as post impact momentum, pₚₒₛₜ, is used by the impact agent's previously trained machine learning policy to find the combination of pre-impact conditions—object mass and velocity for example—which map to the target sensor data. This can be performed quickly, “on-the-the-fly”, because the impact agent is trained off-line using a spacecraft impact emulator. The spacecraft impact emulator provides a simulated physical environment in which the impact agent can learn which combination of pre-impact parameters generate the broader physical effects associated with specific target sensor data. To those skilled in the art, the impact agent learns a policy by applying actions and receiving re-enforcing rewards when those actions converge on a target. This simulation based optimization technique, when applied to a spacecraft experiencing an impact and subsequent perturbation of its motion, allows for quick and accurate estimates of the associated end-to-end physics. Resulting estimates for hazardous debris object velocity vectors, among other pre and post impact parameters, are prepared in a format that can be used by the injector.

The impact agent estimates the future debris field by learning to recognize the physics of a given impact. This is accomplished via the spacecraft impact emulator. The spacecraft impact emulator utilizes a deterministic, large scale computational tool known as a hydrocode. A hydrocode employs numerical methods to solve a set of conservation equations which are closed by a constitutive equation. Hydrocodes can provide detailed information on high velocity impact dynamics, from initial impact to material deformation, shock propagation, and fragmentation. To those skilled in the art, hydrocodes utilize “shock capturing” methods to model the high deformation, shock wave driven process of high velocity impact on a spacecraft. The spacecraft impact emulator is a machine learning enabled hydrocode surrogate that can quickly map pre-impact conditions to post-impact results. The spacecraft impact emulator is created by first simulating a large number of impacts with a hydrocode, each with a different set of pre-impact conditions and post-impact results. With this large database of hydrocode simulation results, an artificial neural network is trained to map the input parameter space to the output parameters space. This learned non-linear function relating input parameters to output parameters is then used as an environment to train the impact agent as discussed in the previous paragraph.

The injector inserts the debris field predictions from the impact agent into an object store for use by the parts of a SOM system handling other modeling tasks such as determination of atmospheric drag or propagation of objects using Keplerian elements.

### DESCRIPTION OF THE DRAWINGS

For a more complete understanding of the invention, reference is made to the following description and accompanying drawings, in which:

FIG. 1 is a block diagram that illustrates the extractor, impact agent, and injector of the debris generator system in some embodiments;

FIG. 2 is a block diagram that illustrates the extractor component of the debris generator system in some embodiments;

FIG. 3 is a block diagram that illustrates the process for training the impact agent using a spacecraft impact emulator in some embodiments;

FIG. 4 is a block diagram that illustrates the spacecraft impact emulator in some embodiments; and

FIG. 5 is a block diagram that illustrates the injector component of the debris generator system in some embodiments.

### DETAILED DESCRIPTION OF THE INVENTION

The following is a detailed description of illustrative embodiments of the present invention. As these embodiments of the present invention are described with reference to the aforementioned drawings, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. For example, it is apparent that additional analysis techniques operating on other raw spacecraft sensor data or derived measurements, such as from ground based platforms, may also be incorporated as input to the impact agent. Hence, these descriptions and drawings are not to be considered in a limiting sense as it is understood that the present invention is in no way limited to the embodiments illustrated.

In broad terms, the debris generator may be described as a set of computer executable instructions executed by one or more computers via routines, programs, or data structures that perform particular tasks which can be distributed as desired in various embodiments. The computer system on which the debris generator may be implemented may be an on-board computer system located on the spacecraft, a ground based computer system, computer readable storage media, or other input devices such as a high performance payload data processor. Data may be transmitted to or from the debris generator via wired or wireless (electromagnetic based) connections.

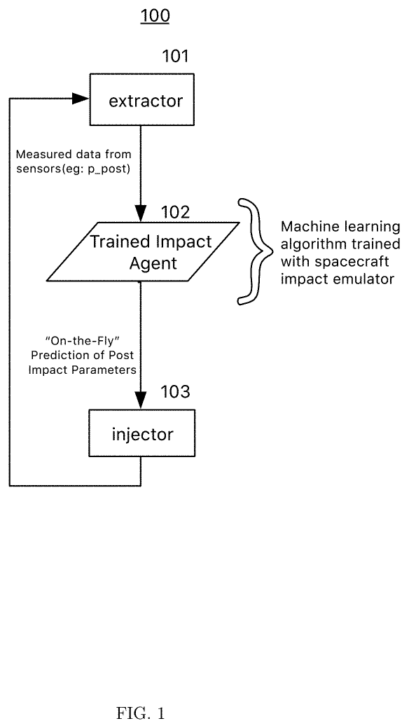

The present invention provides a method and system for capturing impact information and quickly using it to generate a predicted debris field in order to assess the risk to spacecraft from space debris. Most existing methods for predicting debris fields rely on a disparate patchwork of data and mathematical techniques founded on assumptions which severely limit the accuracy of the results. For example, some methods may use a ballistic limit equation to determine whether a target will be perforated by the impacting object, but completely neglect the system effects of impact on important parameters such as spacecraft velocity or altitude. Other methods may incorporate a more physically detailed computational model of the impact event, but then be forced to rely on inaccurate data about the impacting particle because current impact sampling methods are either too expensive, too slow, or insufficient. The debris generator of the current invention, which in one embodiment is a new active sampling method itself, uses a physically detailed model of the impact event in conjunction with data driven techniques applied to readily available satellite sensor measurements. This requires the invention of a new component, the impact agent (block 102), and a new framework for handling the information, the extractor and injector (blocks 101 and 103). FIG. 1 is a flow diagram showing how these components fit together.

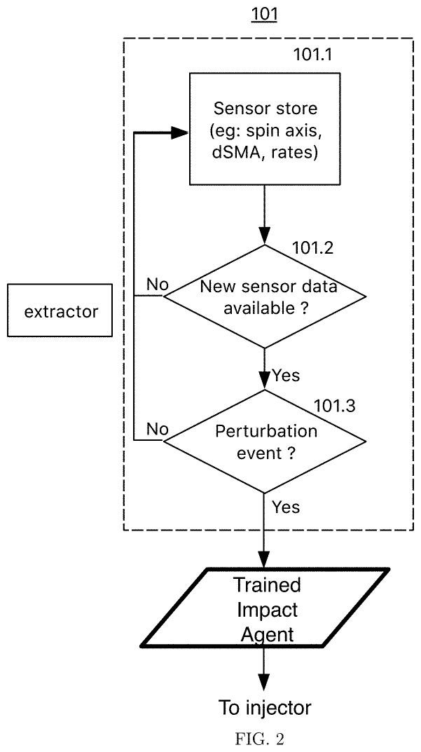

FIG. 2 is a flow diagram for the extractor, whose main function is to store satellite sensor data in a sensor store (101.1) that can be polled for new data (block 101.2) and accessed by the impact agent when a perturbation to the satellite's orbital motion has occurred (block 101.3). The sensor store can include data transmitted directly from available satellite sensors or derived data based on measurements. For example a spacecraft's spin axis can be computed either from on board sensors, or satellite ground tracking information such as antenna modulation or photometry observation. Other embodiments of data that can be housed in the sensor store are delta satellite mean altitude (dSMA) and spacecraft state vectors which include attitude, rate, and spacecraft reaction wheel information. Data may be transmitted to/from the sensor store locally on the spacecraft and/or to/from other nodes in the broader network via wired or wireless (electromagnetic based) connections.

Block 102 of FIG. 1 is the impact agent. The primary output from the impact agent are the velocity vectors of predicted debris. The impact agent is an unsupervised, re-inforced learning computer algorithm which is trained in the spacecraft impact emulator environment to recognize policies corresponding to measured sensor data. In some embodiments that measured sensor data can be the spacecraft change in momentum, pₚₒₛₜ (Equation 1), computed with knowledge of the spacecraft's change in orbital radius using the instantaneous velocity:

$${v}^{2} = \frac{1}{2} {v}_{e}^{2} ( \frac{2}{r} - \frac{1}{a} ) \qquad ( 2 )$$

where:
v=spacecraft orbital velocity
vₑ=escape velocity
r=spacecraft orbital radius
a=spacecraft semi-major axis

In other embodiments, the sensor data used as a target for the trained impact agent can be some combination of parameters including spacecraft state vectors, spin axis, and rotation rates.

The impact agent shown in FIG. 1 contains learned policies correspond to the coupled non-linear physical processes—spacecraft kinematics, shock physics, and orbital mechanics—that map the input parameter state generated by the extractor to the output state stored by the injector. In some embodiments, the impact agent may be trained using a policy gradient algorithm to optimize the post-impact target by following the gradient towards higher rewards. In another embodiment, the impact agent may apply a policy search algorithm to search the pre-impact parameter space for the combination which achieves the desired post impact target.

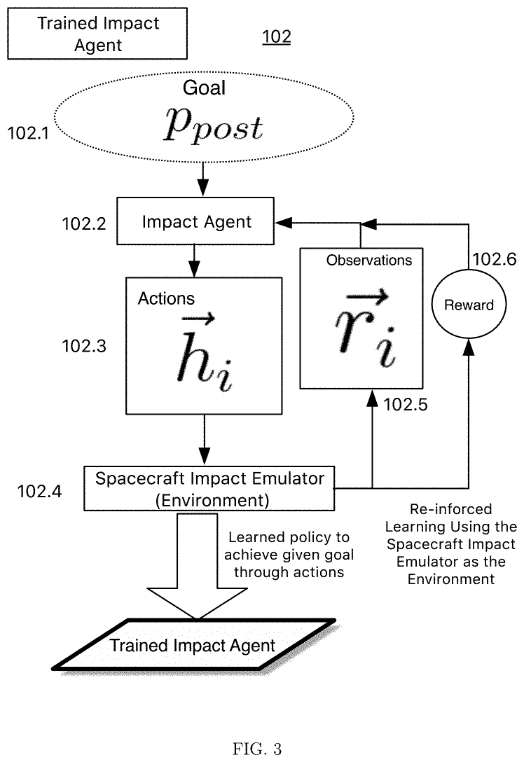

FIG. 3 is a flow diagram showing how the impact agent is trained to learn a given goal (block 102.1), such as post impact momentum pₚₒₛₜ, using available actions (block 102.3). The actions are the set of available input parameters that can be explored by the training algorithm (block 102.2). In some embodiments, the actions can include:

$${\vec{h}}_{i} = [ \begin{matrix}{m}_{obj , i} \\ {v}_{obj , i} \\ {ρ}_{obj , i} \\ {l}_{obj , i} \\ {Z}_{obj , i} \\ {R}_{s} \\ θ\end{matrix} ]$$

where:
m_{obj,i}=mass of impacting object
v_{obj,i}=velocity of impacting object
ρ_{obj,i}=density of impacting object
l_{obj,i}=characteristic length of impacting object
Z_{obj,i}=shock impedance of impacting object
Rₛ=impact location
θ=impact angle

For a given set of actions, the spacecraft impact emulator (block 102.4) generates the corresponding post impact results. In some embodiments, the results can be:

$$\vec{{r}_{i}} = [ \begin{matrix}{β}_{obj , i} \\ {p}_{p o s t} \\ {n}_{d e b} \\ {\vec{n}}_{d e b , i}\end{matrix} ]$$

where:
β_{obj,i}=momentum enhancement factor
pₚₒₛₜ=post impact momentum of the spacecraft
n_{deb}=number of debris cloud fragments generated
\vec{n}_{deb,i}=velocity vector of debris fragment

Using these results, which in the training process are referred to as observations (block 102.5), the impact agent receives rewards (block 102.6) which reinforce pathways that lead to the target post impact parameter space. In some embodiments, the impact agent may use a discount factor to evaluate an action based on the sum of all rewards that follow. To those practiced in the art, this is known as the credit assignment problem.

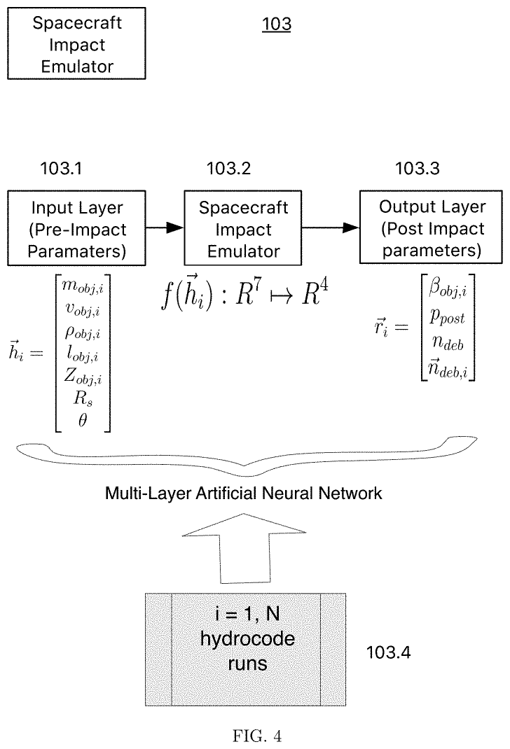

FIG. 4 is a flow diagram showing how the spacecraft impact emulator is constructed. As shown in FIG. 4, N hydrocode simulations (block 103.4), unique to a given spacecraft, are completed in order to generate training data for a data driven technique (blocks 103.1-103.3). In some embodiments, the data driven technique may be a Multi-Layer Perceptron (MLP) using seven (7) input layers \vec{h}ᵢ (block 103.1), multiple hidden layers, and four (4) output layers \vec{r}ᵢ (block 103.3). In other embodiments the input layer may contain another number of input parameters, d, and output parameters, o, such that the spacecraft impact emulator is trained to learn a function ƒ(⋅): R^{d}→R^{o}.

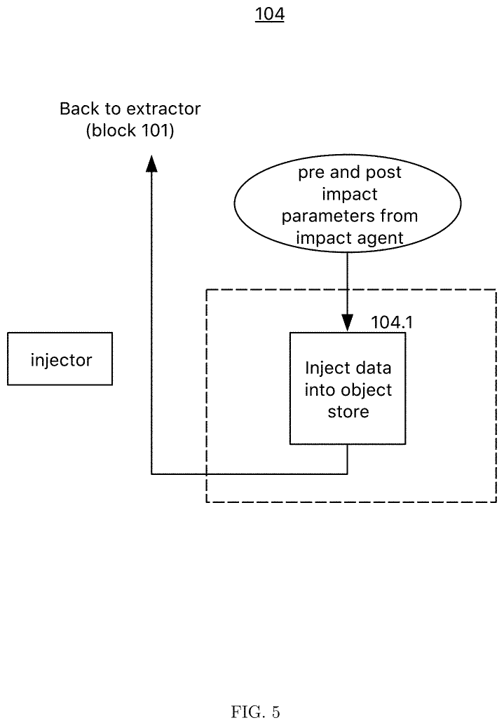

FIG. 5 is a flow diagram showing how the injector is constructed. Results from the trained impact agent are ingested into an object store (block 104.1). The object store, which may be a database or a flatfile, includes an entry for each spacecraft that contains its orbital parameters and results from the trained impact agent calculations. The object store may be initialized based on the two-line element (TLE) of orbiting elements as provided by NORAD. Data from the agent may be transmitted to an object store locally on the spacecraft and/or transmitted to/from other nodes in the broader network via wired or wireless (electromagnetic based) connections.

What is claimed:

1. A method performed by an on-board or ground based computing system for quickly characterizing and cataloging debris strikes using spacecraft sensor data.

2. The method of claim 1 further comprising an extractor which stores satellite sensor information in a sensor store and tests for impact events.

3. The method of claim 1 further comprising a trained impact agent which takes the sensor store information and characterizes the pre and post impact parameters by using sensor information as a target for data driven analysis techniques.

4. The method of claim 3 further comprising a spacecraft impact emulator which provides a virtual environment for training an agent.

5. The method of claim 1 further comprising an injector which injects the computed debris field into a near-term object store for use by other components of a SOM model and near-term debris risk mitigation.

6. The method of claim 1 further comprising multiple on-board or ground based computer systems for calculating debris strike characteristics and sharing data with other nodes in the network for characterizing and cataloging debris.

7. A memory storing computer executable instructions for controlling a computer system to characterize and catalog space debris using in-situ spacecraft data comprising:
i) extractor instructions that extract, process, and store satellite sensor information.
ii) impact agent instructions that calculate impact dynamics and debris characteristics, including pre and post impact parameters, from the sensor store data.
iii) spacecraft impact emulator instructions that can be used to train an agent off-line.
iv) injector instructions that store the debris characteristics for use by other SOM components.
